(19) United States
(12) Patent Application Publication
(10) Pub. No.: US 2006/0108925 A1
(43) Pub. Date: May 25, 2006

(54) Plasma display panel

(75) Inventors: Min Hur, Suwon-si (KR); Hyea-Weon Shin, Suwon-si (KR); Yon-Goo Park, Suwon-si (KR); Sung-Chun Cho, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/281,714

(22) Filed: Nov. 18, 2005

(30) Foreign Application Priority Data
Nov. 23, 2004 (KR) 10-2004-0096208

(51) Int. Cl. H01J 17/49

(52) U.S. Cl. 313/583; 313/584

(57) ABSTRACT

The invention provides a plasma display panel that can reduce a breakdown voltage and enlarge a discharge length to achieve a high luminous efficiency. The plasma display panel includes a first substrate and a second substrate that face each other with a space therebetween that is divided into a plurality of discharge cells. An address electrode extends along a direction on the first substrate, A phosphor layer is formed in discharge cells. A first electrode and second electrode extend along a second direction intersecting the first direction in the space between the first substrate and the second substrate so as to correspond to each of the plurality of discharge cells. The first electrode and the second electrode expand from the first substrate to the second substrate and face each other with an interval therebetween. The address electrode includes one or more first portions that correspond to a discharge space of each discharge cell and a second portion that electrically connects the one or more first portions along the second direction. The width of the first portion is different from that of the second portion.

### CROSS-REFERENCE TO RELATED APPLICATIONS

This application claims priority to and the benefit of Korean Patent Application No. 10-2004-0096208 filed in the Korean Intellectual Property Office on Nov. 23, 2004, the entire content of which is incorporated herein by reference.

### BACKGROUND OF THE INVENTION

1. Field of the Invention

The present invention relates generally to a plasma display panel, and more particularly, to a plasma display panel that can operate with a low driving voltage and high luminance.

2. Description of the Related Art

Generally, a plasma display panel (PDP) is a display device in which vacuum ultraviolet rays emitted from plasma by gas discharge excite phosphors to generate visible light, thereby creating images. Such a plasma display panel has been spotlighted as a next-generation thin display device since it has high resolution and a large screen.

A conventional plasma display panel generally uses a three-electrode surface-discharge type structure. The three-electrode surface-discharge type structure includes a front substrate having two display electrodes formed thereon and a rear substrate which is spaced from the front substrate at a predetermined distance and has address electrodes formed thereon. The space between both substrates is divided into a plurality of discharge cells by barrier ribs, and a phosphor layer is formed in the discharge cell on the rear substrate. Also, a discharge gas is injected into each discharge cell.

Whether discharge occurs or not determined by the address discharge between the address electrode and one of the display electrodes, and sustain discharge for displaying luminance occurs using the display electrodes located on the same surface. Thus, in a conventional plasma display panel, the address discharge is generated by an opposed discharge, and the sustain discharge is generated by surface discharge.

The distance between the display electrode and the address electrode is greater than the distance between two display electrodes, but the breakdown voltage of the address discharge is lower than that of the display discharge. This is because the address discharge is induced by the opposed discharge and thus has the breakdown voltage lower than that of the sustain discharge induced by the surface discharge. Accordingly, if an improved plasma display panel could induce sustain discharge by opposed discharge it would have higher efficiency than that of the conventional plasma display panel.

On the other hand, the plasma discharge within the plasma display panel is affected by a sheath region and a positive column region. The sheath region is a region that consumes most of the voltage in a non-emitting region surrounding a dielectric layer or an electrode, and the positive column region is a region that can actively generate plasma discharge at a very low voltage. Accordingly, the efficiency of the plasma display panel can be improved by increasing the size of the positive column region. The length of the sheath region is not related to the discharge gap, and the positive column region can be enlarged by enlarging the discharge length. However, if the discharge gap is increased to enlarge the discharge length, the breakdown voltage increases.

Also, the efficiency of the discharge gas charged in each discharge cell improves as the partial pressure of Xe gas increases. However, if the partial pressure of Xe gas increases, the breakdown voltage is reduced.

Accordingly, in the conventional plasma display panel, there is a problem in that a low breakdown voltage and high efficiency cannot be simultaneously achieved.

### SUMMARY OF THE INVENTION

The present invention provides a plasma display panel that induces a sustain discharge by an opposed discharge to reduce a breakdown voltage and that also enlarges a discharge length to achieve a high luminous efficiency.

According to an aspect of the invention, an improved plasma display panel includes first and second substrates that face each other with a space therebetween. The space is divided into a plurality of discharge cells. Address electrodes extend along a first direction on the first substrate, and phosphor layers are formed in the discharge cells. First electrodes and second electrodes extending along a second direction that intersects the first direction in the space between the first substrate and the second substrate correspond to the discharge cells. The first and second electrodes expand from the first substrate to the second substrate and face each other with an interval therebetween. Each of the address electrodes includes first portions that correspond to a discharge space of each discharge cell and a second portion that electrically connects the first portions along the first electrode. The width of the first portion is different from that of the second portion.

According to another aspect of the invention, a plasma display panel includes first and second substrates that face each other with a space therebetween. The space is divided into a plurality of discharge cells. Address electrodes extend along a first direction on the first substrate, and phosphor layers are formed in the discharge cells. First electrodes extending along a second direction that intersects the first direction in the space between the first substrate and the second substrate. Second electrodes extend along the second direction between a pair of the first electrodes. The first electrodes and the second electrodes expand from the first substrate to the second substrate and face each other with an interval therebetween. Each of the first electrodes has a first portion that is formed along the second direction and a second portion that protrudes from the first portion to the second electrode.

### BRIEF DESCRIPTION OF THE DRAWINGS

These and/or other aspects and advantages of the invention will become apparent and more readily appreciated from the following description of the embodiments, taken in conjunction with the accompanying drawings.

FIG. 1 is a partial exploded perspective view of a plasma display panel according to a first embodiment of the present invention.

FIG. 2 is a partial cross-sectional view of the assembled plasma display panel taken along the line II-II in FIG. 1.

FIG. 3 is a partial plan view of the plasma display panel according to the first embodiment of the present invention.

FIG. 4 is a partial cross-sectional view of a first modified embodiment of the first embodiment of the present invention.

FIG. 5 is a partial plan view of a second modified embodiment of the first embodiment of the present invention.

FIG. 6 is a partial plan view of a third modified embodiment of the first embodiment of the present invention.

FIG. 7 is a partial cross-sectional view of a fourth modified embodiment of the first embodiment of the present invention.

FIG. 8 is a partial cross-sectional view of a fifth modified embodiment of the first embodiment of the present invention.

FIG. 9 is a partial exploded perspective view of a plasma display panel according to a second embodiment of the present invention.

FIG. 10 is a partial cross-sectional view of the assembled plasma display panel taken along the line X-X in FIG. 9.

FIG. 11 is a partial plan view of the plasma display panel according to the second embodiment of the present invention.

FIG. 12 is a partial plan view illustrating the structure of an electrode corresponding to one discharge cell in the plasma display panel according to the second embodiment of the present invention.

FIG. 13 is a partial plan view illustrating the structure of an electrode corresponding to one discharge cell in a plasma display panel according to a third embodiment of the present invention.

FIG. 14 is a partial plan view illustrating the structure of an electrode corresponding to one discharge cell in a plasma display panel according to a fourth embodiment of the present invention.

FIG. 15 is a partial plan view illustrating the structure of an electrode corresponding to one discharge cell in a plasma display panel according to a fifth embodiment of the present invention.

### DESCRIPTION OF THE EMBODIMENTS

Preferred embodiments of the present invention will now be described with reference to the drawings.

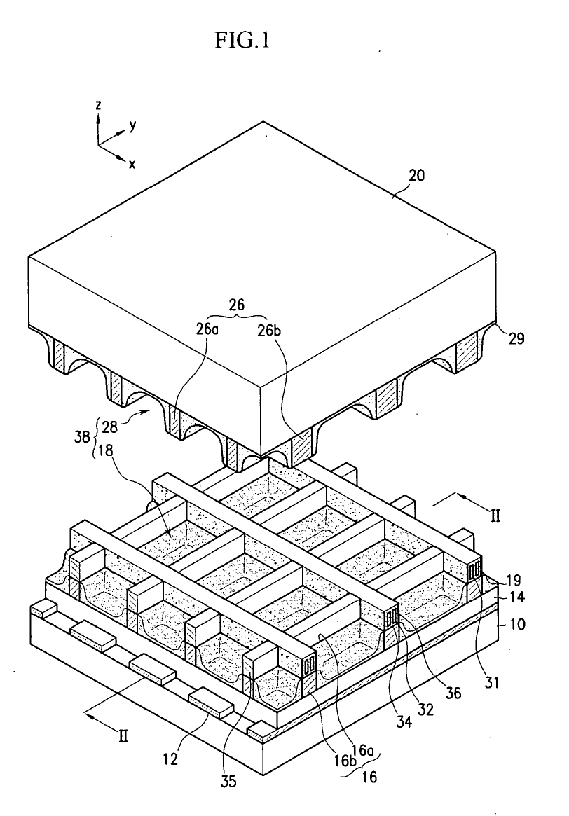

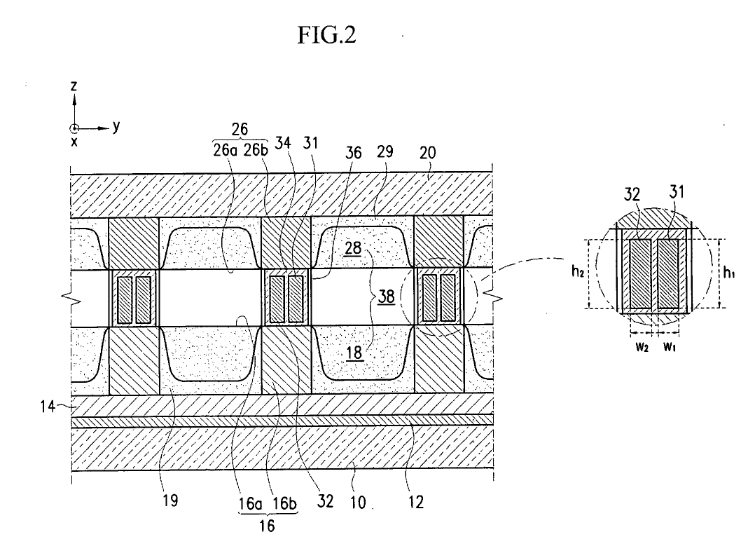

FIG. 1 is a partially exploded perspective view of a plasma display panel manufactured in accordance with the principles of the invention, and FIG. 2 is a partial cross-sectional view of the assembled plasma display panel taken along the line II-II in FIG. 1.

Referring to FIG. 1, the plasma display panel according to the present embodiment includes a first substrate 10 (hereinafter, referred to as “a rear substrate”) and a second substrate 20 (hereinafter, referred to as “a front substrate”) that face each other with a predetermined space therebetween, which is divided into a plurality of discharge cells 38.

In the discharge cell 38, red, green and blue phosphor layers 19 and 29 for absorbing ultraviolet rays and emitting visible rays are formed along a barrier rib surface and a bottom surface, and discharge gas (for example, a gas mixture containing xenon Xe, neon Ne, etc.) is injected into each discharge cell 38. When electronically charged, the gas forms a plasma that emits ultraviolet rays. These ultraviolet ray impinge the phosphor layers 19 and 29, which emit visible rays of light.

Now, the plasma display panel will be described in detail.

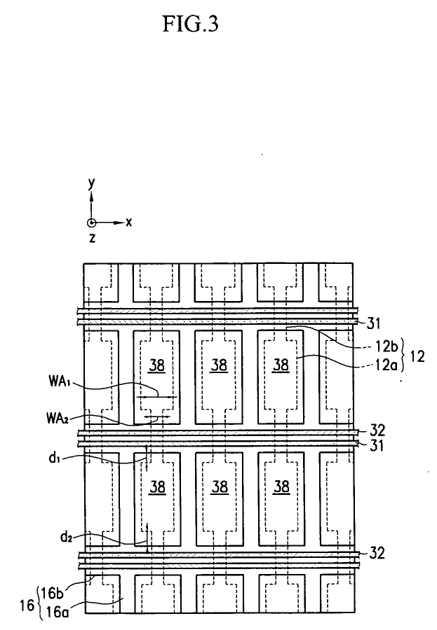

First, on one surface of the rear substrate 10 opposing the front substrate 20, address electrodes 12 are formed along a direction (y axis direction), and a dielectric layer 14 is formed on the entire inner surface of the rear substrate 10 to cover the address electrodes 12. The address electrodes 12 are spaced from each other at predetermined intervals. The address electrodes 12 will be described in detail with reference to FIG. 3.

Barrier ribs 16 and 26 for dividing the discharge cell 38 are formed in the space between the first substrate 10 and the second substrate 20. The barrier ribs 16 and 26 include a first barrier rib layer 16 (hereinafter, referred to as “a rear barrier rib”) protruding toward the front substrate 20 adjacent to the rear substrate 10 and a second barrier rib layer 26 (hereinafter referred to as “a front barrier rib”) protruding toward the rear substrate 10 adjacent to the front substrate 20.

The rear barrier rib 16 is formed on the dielectric layer 14 formed on the rear substrate 10. The rear barrier rib 16 includes first barrier rib members 16a arranged in a direction (y axis direction) parallel with the address electrode 12 and second barrier rib members 16b which are formed in a direction (x axis direction) intersecting the barrier rib member 16a, and divides each rear discharge cell 18 into independent discharge spaces on the rear substrate 10.

Also, the front barrier rib 26 includes third barrier rib members 26a having shapes corresponding to those of the first barrier rib members 16a and fourth barrier rib members 26b having shapes corresponding to those of the second barrier rib members 16b. That is, the third barrier rib members 26a and the fourth barrier rib members 26b are formed on the front substrate 20 along the directions which cross each other to form the front discharge cell 28 corresponding to the rear discharge cell 18.

The rear discharge cell 18 divided by the rear barrier rib 16 and the front discharge cell 28 divided by the front barrier rib 26 combine to substantially form a single discharge cell 38.

Although the rear barrier rib 16 and the front barrier rib 26 include the barrier rib members 16a, 16b, 26a, 26b which cross each other in the present embodiment, the present invention is not so limited. That is, barrier ribs having various shapes can be used and are included in the scope of the present invention. Also, although both the rear barrier rib 16 and the front barrier rib 26 are formed in the present embodiment, the present invention is not limited thereto.

A first phosphor layer 19 is formed in the rear discharge cell 18. A second phosphor layer 29 is formed in the front discharge cell 28. The first phosphor layer 19 is formed at the lateral surfaces of the barrier rib members 16a and 16b forming the rear barrier rib 16 and the bottom surface adjacent to the rear substrate 10. The second phosphor layer 29 is formed at the lateral surfaces of the barrier rib members 26a and 26b forming the front barrier rib 26 and the bottom surface adjacent to the front substrate 20.

Each of the first and second phosphor layers 19 and 29 absorbs vacuum ultraviolet rays in the rear discharge cell 18 and the front discharge cell 28 and generates visible light toward the front substrate 20. Because the second phosphor layer 29 transmits visible light, the second phosphor layer 29 can be formed thinner than the first phosphor layer 19 in order to minimize the loss of the vacuum ultraviolet rays.

Since the rear discharge cell 18 formed by the rear barrier rib 16 and the front discharge cell 28 formed by the front barrier rib 26 substantially form one discharge cell 38, the first phosphor layer 19 and the second phosphor layer 29 preferably emit the same visible light by collision of vacuum ultraviolet rays generated by gas discharge.

Forming the phosphor layers 19 and 29 on either sides of the discharge cell 38 improves the luminance of the PDP.

The present invention however, is not limited to this. In another embodiment, a single phosphor layer can be formed on the rear substrate 10 or the front substrate 20, and this is also included in the scope of the present invention.

The first phosphor layer 19 can be formed by forming a dielectric layer (not shown) and the rear barrier rib 16 on the rear substrate 10, and then coating a phosphor on the dielectric layer. The second phosphor layer 29 can be formed by forming a dielectric layer (not shown),and the front barrier rib 26 on the front substrate 20, and then coating a phosphor on the dielectric layer. Alternatively, the second phosphor layer 29 can be formed by forming the front barrier rib 26 on the front substrate 20 and then coating the phosphor thereon without forming a dielectric layer on the front substrate 20 as shown in the drawing.

Also, the first phosphor layer 19 and the second phosphor layer 29 can also be formed by etching the rear substrate 10 and the front substrate 20 to have the shape corresponding to that of the rear discharge cell 18 and front discharge cell 28 and coating the phosphor layers thereon, respectively. In this embodiment, the rear barrier rib and the rear substrate may be integrally formed of the same material, and the front barrier rib and the front substrate may be integrally formed of the same material.

Also, dielectric layers 34 and 35 should be disposed between the rear barrier rib 16 and the front barrier rib 26, so that first electrodes 31 and second electrodes 32 can be formed in the dielectric layers 34 to intersect and extend through dielectric layers 35. Together, the dielectric layers 34 and 35 insulate the electrodes 31 and 32 and store wall charges generated by the discharge.

The first electrodes 31 and the second electrodes 32 may have stripe shapes that extend along a direction intersecting the address electrode 12 at both sides of the discharge cell 38. The first electrodes 31 and the second electrodes 32 may be disposed in parallel between the second barrier rib member 16b and the fourth barrier rib member 26b while intersecting the first barrier rib member 16a and the third barrier rib 26a.

Referring to FIG. 2, in the present embodiment, the cross section of the first electrode 31 taken along perpendicularly to the longitudinal direction can have the length h₁ of a perpendicular direction to the substrates 10 and 20 greater than the length w₁ of a parallel direction to the substrates 10 and 20. The cross section of the second electrode 32 taken along perpendicularly to the longitudinal direction can have the length h₂ of a perpendicular direction to the substrates 10 and 20 greater than the length w₂ of a parallel direction to the substrates 10 and 20. Accordingly, the opposed discharge can be induced easier and thus high emission efficiency can be obtained.

In the present embodiment, since the first electrodes 31 and the second electrodes 32 are disposed on the side of the discharge cell 38 having substantially low contribution to the display, the metal electrode having excellent conductivity can be used.

In one embodiment, the first electrode 31 selects the discharge cell 38 which will be turned on when a scan pulse voltage is applied during the address period together with the address electrode 12, and the second electrode 32 participates in the discharge of the sustain period to display an image together with the first electrode 31. However, since the roles of the electrodes can vary with an applied signal voltage, the present invention is not limited to this.

The first electrode 31, the second electrode 32, and the dielectric layers 34 and 35 surrounding the electrodes can be manufactured with a thick film ceramic sheet (TFCS) method. That is, the dielectric layers 34 and intersecting dielectric layers 35 having the first electrode 31 and the second electrode 32 therein can be separately manufactured and then connected between the rear barrier rib 16 and the front barrier rib 26.

Also, a MgO protecting film 36 can be formed on the surfaces of the dielectric layers 34 and 35. Additionally, the MgO protecting film 36 can be formed on a portion which is exposed to the plasma discharge generated in the discharge space within the discharge cell 38. In the present embodiment, since the first electrode 31 and the second electrode 32 are disposed on a portion having substantially low contribution to the display between the substrates 10 and 20, the MgO protecting film 36 coated on the dielectric layer 34 for covering the first electrode 31 and the second electrode 32 can be composed of MgO having visible-light transmission characteristics. The visible-light non-transmission MgO has a secondary electron emission coefficient higher than that of visible-light transmission MgO, and thus the breakdown voltage can be reduced even more.

Hereinafter, the address electrode 12 will be described in detail with reference to FIG. 3. FIG. 3 is a partial plan view of the plasma display panel according to the first embodiment of the present invention.

Referring to FIG. 3, in the present embodiment, the address electrode 12 includes a first portion 12a which is formed in correspondence with the discharge cell 38 and a second portion 12b which electrically connects the first portions 12a. The planar shape of the first portion 12a can have various shapes according to the shape of the discharge cell 38. Thus, the planar shape of the first portion 12a is rectangular in the present embodiment.

In one embodiment, the widths of the first portion 12a and the second portion 12b are different from each other. In detail, the width WA₁ of the central first portion 12a can be greater than the width WA₂ of the end second portion 12b. Here, the widths of the first portion 12a and the second portion 12b are measured along a direction (x axis direction) intersecting the longitudinal direction of the address electrode 12.

The first portion 12a of the address electrode 12 is formed in the discharge space of the discharge cell 38 to generate the address discharge with the first electrodes 31. Accordingly, in the present embodiment, by increasing the width WA₁ of the first portion 12a, the breakdown voltage of the address discharge is reduced and an amount of wall charges are stored in the dielectric layer 34 and 35 surrounding the first electrode 31 and the second electrode 32.

By reducing the width WA₂ of the second portion 12b which has a low contribution to the address discharge, the current flowing in the address electrode 12 can be reduced. Accordingly, the power consumption can be reduced.

As viewed from the front surface of the substrates 10 and 20, the first portion 12a of the address electrode 12 and the first electrode 31 are spaced from each other as much as a first interval d1, and the first portion 12a and the second electrode 32 are spaced from each other as much as a second interval d2. Because the first portion 12a of the address electrode 12 and the first electrode 31 participate in the address discharge, the breakdown voltage of the address discharge can be efficiently reduced by allowing the first interval d1 to be smaller than the second interval d2, that is, by forming the first portion 12a close to the first electrode 31. Also, the first interval d1 and the second interval d2 can be substantially equal to each other.

On the other hand, as shown in FIG. 3, in the present embodiment, a pair including a first electrode 31 and a second electrode 32 is located for each discharge cell 38. And the arrangement of the first electrode 31 and the second electrode 32 can be sequentially repeated in a pair of discharge cells 38 which are adjacent to each other in a parallel direction (y axis direction) with the address electrode 12.

Hereinafter, modified embodiments of the first embodiment of the present invention will be described in detail. Since the modified embodiments of the first embodiment have the same basic structure as the first embodiment, the same components as the first embodiment are indicated by the same reference numerals.

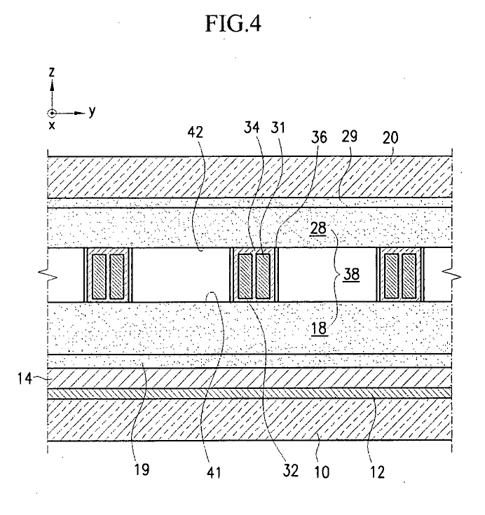

FIG. 4 is a partial cross-sectional view of a first modified embodiment of the first embodiment of the present invention.

Referring to FIG. 4, in the present modified embodiment, a rear barrier rib 41 and a front barrier rib 42 have stripe shapes that extend in a direction (y axis direction) parallel with an address electrode 12. First electrodes 31 and second electrodes 32 are formed along a direction (x axis direction) while intersecting the rear barrier rib 41 and the front barrier rib 42. In the invention, various barrier rib structures can be used.

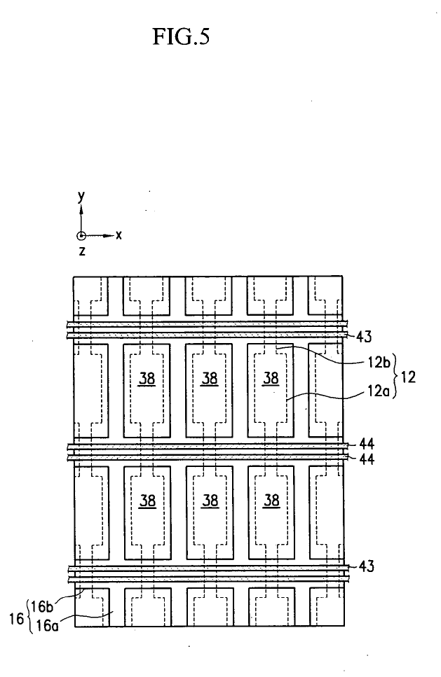

FIG. 5 is a partial plan view of a second modified embodiment of the first embodiment of the present invention.

Referring to the modified embodiment of FIG. 5, each discharge cell 38 may include a first electrode 43 positioned at one end thereof and a second electrode 44 positioned at the opposite end thereof. And, pairs of adjacent first electrodes 43 and pairs of adjacent second electrodes 44 are formed between discharge cells 38.

This arrangement is possible because adjacent first electrodes 43 are spread apart and insulted from each other and because adjacent second electrodes 44 are also spaced apart and insulated from each other. Additionally, the use of matrix-shaped dielectric layers prevents cross-talk between adjacent discharge cells 38.

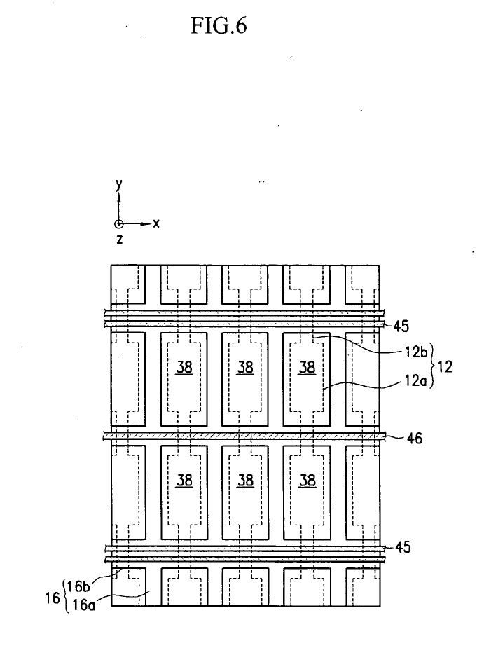

FIG. 6 is a partial plan view of a third modified embodiment of the first embodiment of the present invention.

Referring to FIG. 6, in the present modified embodiment, a pair of the discharge cells 38 which is adjacent to each other in a direction (y axis direction) parallel with the address electrode 12 shares a second electrode 46. Accordingly, the electrodes have the arrangement of the first electrode 45, the second electrode 46, and the first electrode 45 in a pair of the discharge cells 38. Accordingly, the second electrode 46 which functions as the sustain electrode commonly participates in the sustain discharge of a pair of the discharge cells 38.

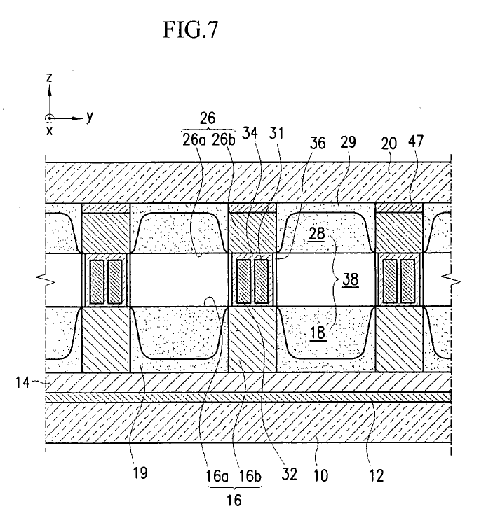

FIG. 7 is a partial cross-sectional view of a fourth modified embodiment of the first embodiment of the present invention.

Referring to FIG. 7, in the present modified embodiment, a black layer 47 is formed adjacent to the front substrate 20. The black layer 47 can be formed on the surface of the front substrate 20 or on a dielectric layer (not shown) formed on the front substrate 20.

By forming the black layer 47 on the front substrate 20, external light is prevented from being reflected and thus bright room contrast can be improved. By forming the black layer 47 in a portion in which a first electrode 31 and second electrode 32 are formed, the visible light generated by the discharge is not blocked and thus bright room contrast can be improved.

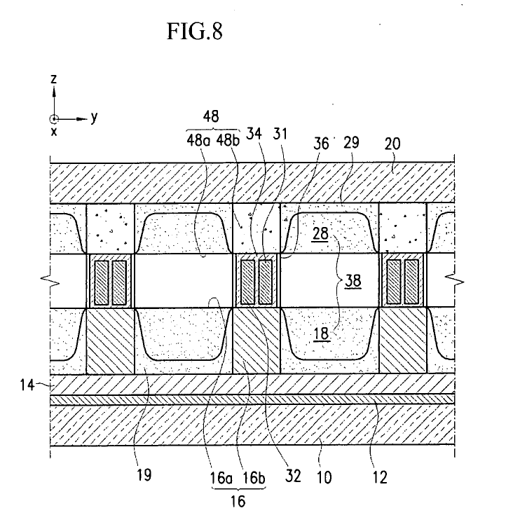

FIG. 8 is a partial cross-sectional view of a fifth modified embodiment of the first embodiment of the present invention.

Referring to FIG. 8, in the present modified embodiment, at least one of the barrier ribs composing a front barrier rib 48 and a rear barrier rib 16 is colored to improve bright room contrast. For example, the front barrier rib 48 can be colored with a black pigment. The black pigment can be, for example, at least one of FeO, RuO₂, TiO, Ti₃O₅, Ni₂O₃, CrO₂, MnO₂, Mn₂O₃, Mo₂O₃, Fe₃O₄ or combination thereof.

Hereinafter, a plasma display panel according to a second embodiment of the present invention will be described in detail. Since the basic structure of the second embodiment of the present invention is identical with or similar to the first embodiment, the description of the identical or similar structure will be omitted.

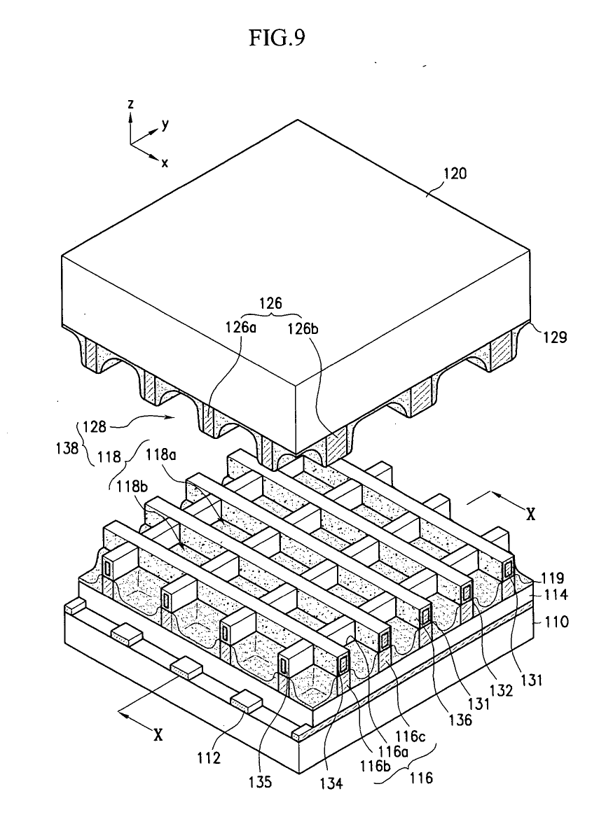

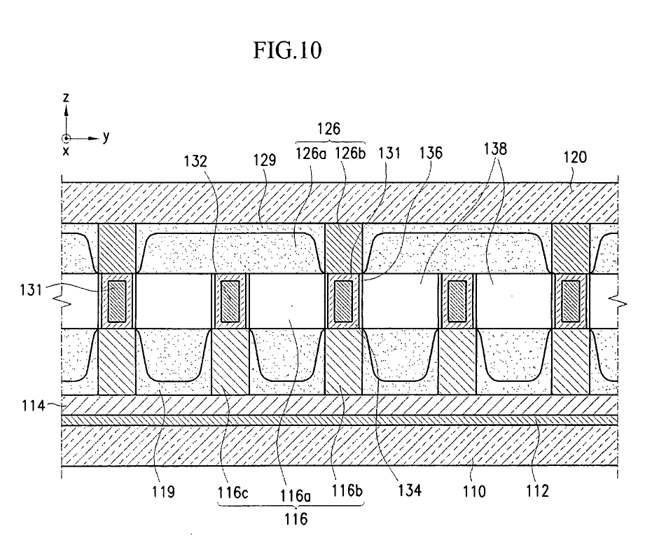

FIG. 9 is a partial exploded perspective view of a plasma display panel manufactured in accordance with a second embodiment of the present invention, and FIG. 10 is a partial cross-sectional view of the assembled plasma display panel taken along the line X-X in FIG. 9.

Referring to FIGS. 9 and 10, a rear barrier rib 116 according to this embodiment includes a fifth barrier rib member 116c for dividing a rear discharge cell 118 which is formed on a rear substrate 110 between second barrier rib members 116b into two discharge spaces 118a and 118b.

In other words, in the present embodiment, the rear barrier rib 116 includes a first barrier rib member 116a which is formed in a direction (y axis direction) parallel with an address electrode 112, a second barrier rib member 116b which is formed in a direction (x axis direction) intersecting the first barrier rib member 116a and divides each rear discharge cell 118 formed on the rear substrate 110 into independent spaces, and a fifth barrier rib member 116c which is formed between the second barrier rib members 116b in a direction (x axis direction) parallel with the second barrier rib members 116b and divides the rear discharge cell 118 into two discharge spaces 118a and 118b.

The front barrier rib 126 includes the third barrier rib member 126a which is formed in a shape corresponding to that of the first barrier rib member 116a and the fourth barrier rib member 126b which is formed in a shape corresponding to that of the second barrier rib member 116b to form a front discharge cell 128 which corresponds to the discharge cell 118 on a front substrate 120.

The rear discharge cell 118 divided by the rear barrier rib 116 and the front discharge cell 128 divided by the front barrier rib 126 may form one discharge cell 138.

In addition, matrix-shaped dielectric layers 134 and 135 are arranged between the front barrier rib 116 and the rear barrier rib 126. A pair of electrodes that includes a first electrode 131 and a second electrode 132, which participates in the discharge of each discharge cell 138, formed in the dielectric layers 134 and 135. A MgO protecting film 136 can be formed on the surface of each of the dielectric layers 34 and 35.

The second electrode 132 selects the discharge cell 138 which will be turned on when a scan pulse voltage is applied during an address section together with the address electrode 112, and the first electrode 131 participates in the discharge of the sustain section together with the second electrode 132 to display an image. However, since the function of each of the electrodes may vary depending on an applied signal voltage, the function described above may be removed.

The first electrodes 131 are formed in a direction (x axis direction) intersecting the address electrode 112 at both sides of each discharge cell 138. Since the first electrodes 131 are arranged along the x axis direction between the second barrier rib member 116b and the fourth barrier rib member 126b therebetween, they can be a reference for dividing the discharge cells 138 which are adjacent to each other in a direction (y axis direction) parallel with the address electrode 112.

The second electrode 132 is formed between a pair of the first electrodes 131 along a direction (x axis direction) that parallels with the first electrodes 131 while intersecting each discharge cell 138 Accordingly, the first electrode 131 and the second electrode 132 are spaced from and face each other in each discharge cell 138.

In the present embodiment, a discharge gap of the sustain discharge which is generated between the first electrode 131 and the second electrode 132 is reduced and thus a breakdown voltage can be reduced even more. That is, since the discharge is generated between the second electrode 132 intersecting the discharge cell 138 and a pair of the first electrodes 131 which are disposed at both side of the discharge cell, the discharge gap between the first electrode 131 and the second electrode 132 which participate in the discharge sustaining is reduced by half. Accordingly, the driving occurs using a low breakdown voltage.

In the present embodiment, since the first electrodes 131 are formed at an area of the discharge cell 138 that contributes little to the display discharge, they can be made of a metal electrode having excellent conductivity. Also, the second electrodes 132 can be made of a metal electrode having excellent conductivity. When the first electrodes 131 and the second electrodes 132 are formed into an opaque metal electrode, bright room contrast can be improved.

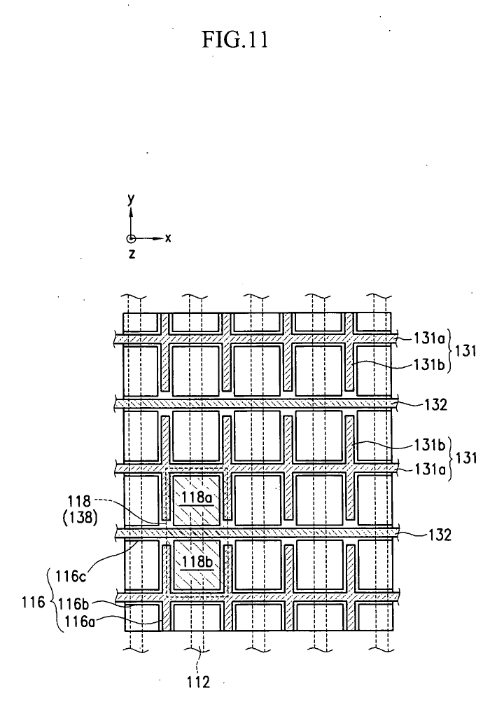

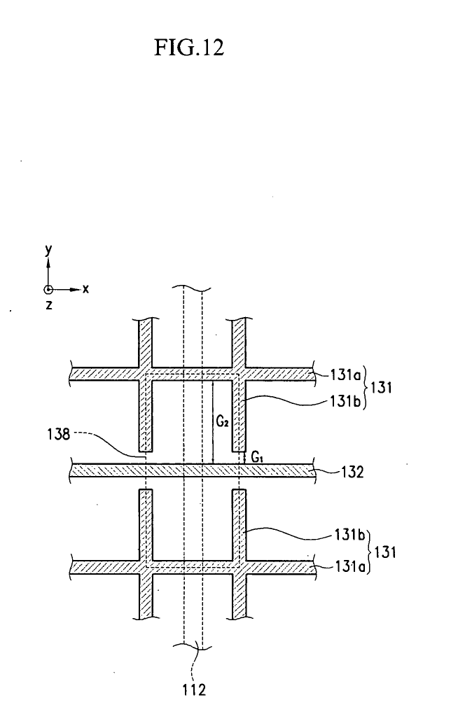

The structures of the first electrode 131 and the second electrode 132 will be described in detail with reference to FIGS. 11 and 12 together FIGS. 9 and 10. FIG. 11 is a partial plan view of the plasma display panel according to the second embodiment of the present invention, and FIG. 12 is a partial plan view illustrating the structure of an electrode corresponding to one discharge cell in the plasma display panel according to the second embodiment of the present invention.

In the present embodiment, the address electrodes 112 formed along a direction (y axis direction) in the front substrate 110 have a uniform line width.

Referring to FIG. 11, the first electrode 131 includes a first portion 131a which is formed along a direction (x axis direction) intersecting the address electrode 112 and a second portion 131b which protrudes from the first portion 131a towards, but does not contact, the second electrode 132. The first portion 131a is located between the second barrier rib member 116b and the fourth barrier rib member 126b, and the second portion 131b is located between the first barrier rib member 116a and the third barrier rib member 116b.

In the present embodiment, the first portion 131a is shared by a pair of the discharge cells 138 which are adjacent to each other in a direction (y axis direction) parallel with the address electrode 112, and the second portion 131b is shared by a pair of the discharge cells 138 which are adjacent to each other in a direction (x axis direction) intersecting the address electrode 112. In such a configuration, the second portion 131b has a uniform line width.

The second portions 131b of a pair of the first electrodes 131 are symmetrically formed at both sides of the discharge cell 138 and face each other across gaps separating them from the second electrode 132 that divides each discharge cell 138. The first electrode 131 having the above-mentioned structure can be formed to surround three sides of each discharge cell 138. That is, in two discharge spaces forming each discharge cell 138, the first electrodes 131 are disposed at three sides of the discharge cell and the second electrode 132 is disposed at one side thereof and thus discharge space of the sustain discharge generated between the first electrode 131 and the second electrode 132 can be used more efficiently.

With this structure, as shown in FIG. 12, in a direction (y axis direction) parallel with the address electrode 112, the distance between the first electrode 131 and the second electrode 132 at the central portion of the discharge cell 138 is greater than that at both sides of the discharge cell 138. That is, the first electrode 131 and the second electrode 132 have short gaps G1 at both edge portions of the discharge cell 138 and have long gaps G2 at the central portion of the discharge cell 138.

Accordingly, the sustain discharge generated between the first electrode 131 and the second electrode 132 is initiated at the short gap G1 of the edge portion of the discharge cell 138 and is diffused into the long gap G2 of the central portion of the discharge cell 138. The sustain discharge is initiated at the short gap G1 so as to reduce the breakdown voltage and main discharge is sustained at the long gap G2 having a relatively long discharge length so as to improve the discharge efficiency.

Also, since the breakdown voltage can be efficiently reduced in the present embodiment, solves a longstanding conventional problem, which could not efficiently increase the partial pressure of Xe gas. That is, in the present embodiment, the partial pressure of Xe gas can be increased, and thus the discharge efficiency can be improved.

Hereinafter, the third through fifth embodiments will be described in detail. The basic structures of the third through fifth embodiments may be identical with or similar to that of the second embodiment.

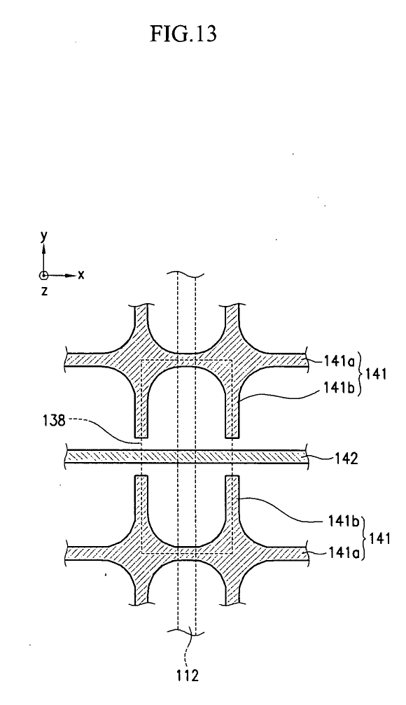

FIG. 13 is a partial plan view showing the structure of an electrode corresponding to one discharge cell in a plasma display panel according to a third embodiment of the present invention.

First electrodes 141 are formed in a direction (x axis direction) intersecting an address electrode 112 at both sides of each discharge cell 138, and second electrodes 142 are formed between the first electrodes 141 while passing through the discharge cell 138.

Each of the first electrodes 141 includes a first portion 141a which is formed along a direction (x axis direction) intersecting the address electrode 112, and second portions 141b which are formed at both sides of the discharge cell 138 along a direction (y axis direction) parallel with the address electrode 112 and face each other. Accordingly, the first electrode 141 surrounds three sides of the discharge cell 138 and thus the discharge space can be used efficiently.

Referring to FIG. 13, in the present embodiment, the line width of the second portion 141b of the first electrode 141 gradually increase from the end thereof to the first portion 141a, the surface facing opposite the second electrode 142 is a curved surface, and thus the diffusion of the discharge can be easily performed.

In the present embodiment, the sustain discharge generated between the first electrode 141 and the second electrode 142 is initiated at the short gap of the edge portion of the discharge cell 138 and is diffused into the long gap of the central portion of the discharge cell, and thus the efficiency can be improved while reducing the breakdown voltage.

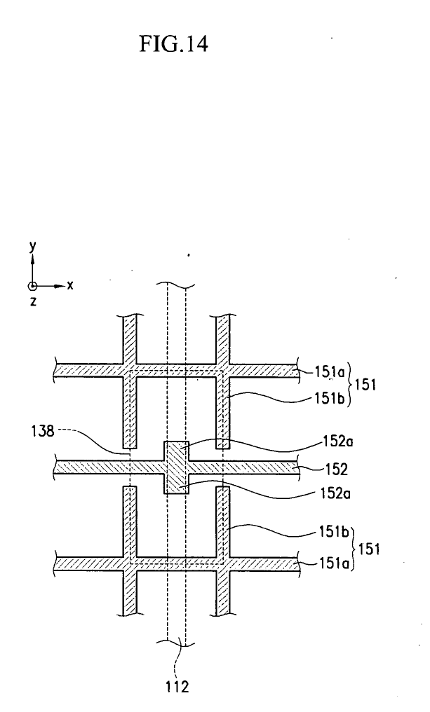

FIG. 14 is a partial plan view illustrating the structure of an electrode corresponding to one discharge cell in a plasma display panel according to a fourth embodiment of the present invention.

First electrodes 151 are formed in a direction (x axis direction) intersecting an address electrode 112 at both sides of each discharge cell 138, and second electrodes 152 are formed between the first electrodes 151 while passing through the discharge cell 138. The first electrodes 151 and the second electrode 152 face each other and thus the sustain discharge can be induced by the opposed discharge to reduce the breakdown voltage.

At this time, each of the first electrodes 151 includes a first portion 151a which is formed along a direction (x axis direction) intersecting the address electrode 112, and second portions 151b which are formed at both sides of the discharge cell 138 along a direction (y axis direction) parallel with the address electrode 112 and face each other. Accordingly, the first electrode 151 surrounds three sides of the discharge cell 138 and thus the discharge space can be used efficiently.

Referring to FIG. 14, in the present embodiment, a protrusion 152a protruding toward the first portion 151a of the first electrode 151 is connected to the second electrode 152. The protrusion 152a of the second electrode 152 is preferably formed at the central portion of each discharge cell 138 between the second portions 151b that face each other in the discharge cell 138, and the planar shape of the protrusion 152a is rectangular. Since the planar shape of the protrusion 152a is rectangular, the portion forming the short gap between the first electrode 151 and the second electrode 152 can be widened.

In operation, the sustain discharge is initiated at the short gap between the protrusion 152a and the first electrode 151 located at the edge portion of the discharge cell 138, and thus the breakdown voltage can be reduced.

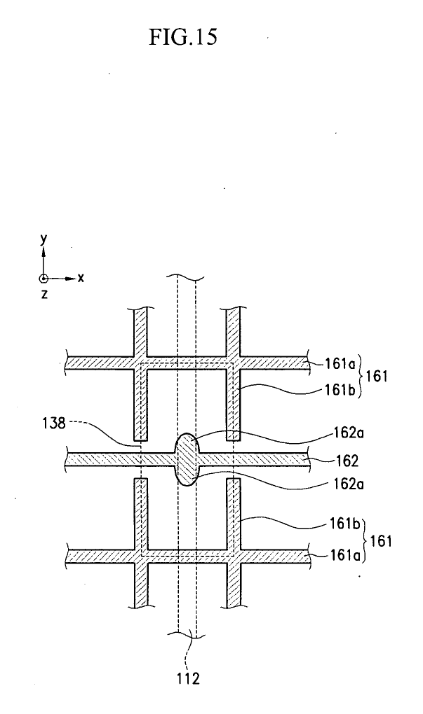

FIG. 15 is a partial plan view illustrating the structure of an electrode corresponding to one discharge cell in a plasma display panel according to a fifth embodiment of the present invention.

Referring to FIG. 15, a protrusion 162a protruding to a first portion 161a of a first electrode 161 is formed at a second electrode 162. The protrusion 162a of the second electrode 162 is formed between the second portions 161b that face each other in the discharge cell 138 at the central portion of each discharge cell 138, and the planar shape of the protrusion 162 is semicircular or semi-elliptical.

Although the preferred embodiments of the invention have been described hereinabove, the invention is not limited to the embodiments. It should be understood that various modified embodiments, which may be made within the scope of the invention read on the appended claims, the detailed description of the invention, and the accompanying drawings, will still fall within the spirit and scope of the invention.

What is claimed is:

1. A plasma display panel comprising:
a first substrate and a second substrate that face each other with a space there between that is divided into a plurality of discharge cells;
an address electrode that extends along a first direction on the first substrate;
a phosphor layer that is formed in the discharge cells; and
a first electrode and a second electrode that extend along a second direction intersecting the first direction in the space between the first substrate and the second substrate so as to correspond to the discharge cells wherein the first electrode and the second electrode project from the first substrate to the second substrate and are positioned to oppose each other with an interval therebetween, wherein the address electrode includes a first portion that corresponds to a discharge space of each discharge cell and a second portion that electrically connects first portions, and wherein a width of the first portion is different from a width of the second portion.

2. The plasma display panel of claim 1, wherein the width of the first portion is greater than a width of the second portion.

3. The plasma display panel of claim 1, wherein a planar shape of the first portion of the address electrode is rectangular.

4. The plasma display panel of claim 1, wherein an address discharge between the address electrode and the first electrode selects a discharge cell when scan pulse voltages are sequentially applied during an address period, and the second electrode generates a sustain discharge together with the first electrode,
wherein, as viewed from a front surface of the second substrate, the first portion of the address electrode and the first electrode are spaced from each other with a first interval therebetween, and the first portion of the address electrode and the second electrode are spaced from each other with a second interval therebetween, and the second interval is larger than the first interval.

5. The plasma display panel of claim 1, further comprising a dielectric layer formed substantially surrounding each of the first electrode and the second electrode.

6. The plasma display panel of claim 1, wherein the space between the first substrate and the second substrate is divided by a barrier rib, and the barrier rib comprises a first barrier rib layer that is formed adjacent to the first substrate and a second barrier rib layer that is formed adjacent to the second substrate.

7. The plasma display panel of claim 6, wherein the first electrode and the second electrode are located in a dielectric layer disposed between the first barrier rib layer and the second barrier rib layer.

8. The plasma display panel of claim 1, wherein each discharge cell comprises a pair of electrodes that consists of the first electrode and the second electrode.

9. The plasma display panel of claim 1, wherein at least one of the first electrode and the second electrode is shared by a pair of discharge cells that are adjacent to each other in the first direction.

10. A plasma display panel comprising:
a first substrate and a second substrate that face each other with a space therebetween that is divided into a plurality of discharge cells;
an address electrode that extends along a first direction on the first substrate;
a phosphor layer that is formed in the discharge cells;
a first electrode that extends along a second direction intersecting the first direction in the space between the first substrate and second substrate; and
a second electrode that extends along the second direction between a pair of the first electrodes in the space between the first substrate and the second substrate,
wherein the first electrode and the second electrode project from the first substrate to the second substrate so as to face each other with an interval therebetween, and wherein the first electrode includes a first portion that is formed along the second direction and a second portion that protrudes from the first portion to the second electrode.

11. The plasma display panel of claim 10, wherein the first portion of the first electrode is shared by a pair of discharge cells that are adjacent to each other in the first direction.

12. The plasma display panel of claim 10, wherein the second portion of the first electrode is shared by a pair of discharge cells that are adjacent to each other in the second direction.

13. The plasma display panel of claim 10, further comprising a dielectric layer formed substantially surrounding each of the first electrode and the second electrode.

14. The plasma display panel of claim 10, wherein the space between the first substrate and the second substrate is divided by a barrier rib, and the barrier rib includes a first barrier rib layer that is formed adjacent to the first substrate and a second barrier rib layer that is formed adjacent to the second substrate.

15. The plasma display panel of claim 14, wherein the first electrode and the second electrode are located in a dielectric layer disposed between the first barrier rib layer and the second barrier rib layer.

16. The plasma display panel of claim 10, wherein the second portion of the first electrode is formed at both sides of each discharge cell along the first direction so as to face each other.

17. The plasma display panel of claim 16, wherein a distance between the first electrode and the second electrode at a central portion of the discharge cell measured in the first direction is larger than that at both sides of the discharge cell.

18. The plasma display panel of claim 16, wherein the first electrode substantially surrounds three sides of each discharge cell.

19. The plasma display panel of claim 10, wherein the second portion of the first electrode has a substantially uniform line width.

20. The plasma display panel of claim 10, wherein a line width of the second portion of the first electrode gradually increases from an end thereof to the first portion.

21. The plasma display panel of claim 20, wherein a surface of the first electrode facing the second electrode is a curved surface.

22. The plasma display panel of claim 10, wherein a protrusion protruding toward the first portion of the first electrode is formed at the second electrode.

23. The plasma display panel of claim 22, wherein second portions of first electrodes are formed at both sides of each discharge cell along the first direction so as to face each other, and the protrusion of the second electrode is disposed between the second portions of the first electrodes that face each other in each discharge cell.

24. The plasma display panel of claim 22, wherein a planar shape of the protrusion of the second electrode is rectangular, semicircular, or semi-elliptical.

25. The plasma display panel of claim 10, wherein the first electrode is located at both sides of each discharge cell and the second electrode passes through each discharge cell.
